(19) United States
(12) Patent Application Publication
(10) Pub. No.: US 2026/0115790 A1
(43) Pub. Date: Apr. 30, 2026

(54) METAL MATRIX COMPOSITES AND METHODS OF FORMULATING THE SAME

(71) Applicant: Massachusetts Institute of Technology, Cambridge, MA (US)

(72) Inventors: Alexander David O'Brien, Cambridge, MA (US); Emre Tekoglu, Cambridge, MA (US); Ju Li, Weston, MA (US)

(21) Appl. No.: 18/805,512

(22) Filed: Aug. 14, 2024

Related U.S. Application Data
(60) Provisional application No. 63/532,555, filed on Aug. 14, 2023.

(51) Int. Cl. B22F 1/12; B22F 1/05; B22F 10/28; B33Y 10/00; B33Y 70/10; C22C 29/00; C22C 29/06; C22C 29/14

(52) U.S. Cl. CPC B22F 1/12; B22F 1/05; B33Y 70/10; C22C 29/005; C22C 29/067; C22C 29/14; B22F 10/28; B22F 2301/15; B22F 2302/05; B22F 2302/105; B22F 2304/10; B33Y 10/00

(57) ABSTRACT

Metal matrix composites that include a base metal material and a ceramic additive to form composites strengthened by the additives to improve performance in extreme environments are disclosed. Typically the additive is about 2% of the total volume, up to about 10% of the total volume. The particle sizes are typically less than about 100 micrometers, and average about 40 micrometers, while maintaining a spherical shape of the same. The resulting composites can be used to print components for use in extreme environments, such as using additive manufacturing techniques like laser powder bed fusion. Techniques for formulating these composites, and for printing the resulting components using the composites, are also provided.

### CROSS REFERENCE TO RELATED APPLICATION

The present disclosure claims priority to and the benefit of U.S. Provisional Application No. 63/532,555, entitled “Metal Matrix Composites and Methods of Formulating the Same,” filed on Aug. 14, 2023, the content of which is incorporated by reference herein in its entirety.

### FIELD

The present disclosure relates to metal matrix composites, and more particularly relates to various composites that have one or more metal or metallic materials as a base and one or more ceramic additives, as well as techniques for formulating such metal matrix composites.

### BACKGROUND

Nickel (Ni)-based superalloys are advanced engineering materials that are widely used in industries such as aerospace, marine, energy, and nuclear due, at least in part, to their exceptional high-temperature strength, corrosion, and oxidation resistance in harsh environments. Inconel 718 (In718), which is an exemplar Nickel-Chromium-Iron (Ni—Cr—Fe)-based superalloy, has found use in aircraft engines and gas turbines, owing to its superior mechanical stability and corrosion resistance at elevated temperatures up to 650° C. to 700° C. Despite the excellent historic performance of materials like In718, however, the recent push for cleaner energy has driven significant efforts for the design of more efficient power generation systems, in turn creating a need for further enhanced materials that will be able to accommodate the harsher working conditions these systems require.

Advanced materials are often created by enhancing the properties of existing metals through forming composite structures with particulate reinforcements, such as ceramic particulate reinforcements, referred to herein as metal matrix composites (MMC). MMCs can be produced in different manners. Traditional techniques for formulating such compositions can involve melting and casting in a mold. However, this method frequently produces inhomogeneous distribution of the ceramic particulates, resulting in limited usability. Other techniques include powder metallurgy (PM), a process that involves ball milling for mixing, diffusion, and sintering for consolidation. Although PM may be capable of producing homogeneous components with good properties, it is also a time consuming and expensive process. Furthermore, PM is severely limited in geometry and scalability, making it inadequate for producing complex industrial parts with near-net shapes. Additionally, to the extent superalloy MMCs had been created prior to the present disclosure, the techniques used to manufacture the same resulted in materials with undesirable deficiencies. For example, the production of titanium diboride (TiB₂)-reinforced In625 superalloy MMCs by laser aided additive manufacturing was reported to have enhanced microhardness, tensile strength, and elongation values, but at the expense of reduced wear rates and coefficient of friction values, likely due to the aggregation of nano-sized TiB₂ in grain boundaries.

Accordingly, there is a need for formulations that can achieve improvement in strength and high temperature durability, and which can minimize cracking formation during high-pressure and high-temperature applications.

### SUMMARY

The metal matrix composites (MMCs) of the present disclosure can allow for the production of components that achieve high levels of strength and extreme environment survivability beyond base metal alloys through incorporation of small quantities of ceramic additives. While some forms of these types of materials have been used, for example, in the nuclear and aviation/aerospace fields, the present disclosure provides significant expansion of the concepts by implementing these materials using new geometries, new size scales, and new material combinations. Such implementations were previously hindered, at least in part, by the limitations of the manufacturing methods used to produce such materials, as well as the manufacturing methods that used the materials to produce parts. The AM techniques of the present embodiments may overcome the difficulties previously associated with formulating MMCs. For example, the present techniques can create nanoparticles that can change phase transformation behaviors of the materials involved. The present disclosure can provide for new combinations of MMC materials, including combinations that utilize Inconel 718, Inconel 939 (In939), and CMSX-4 Ni-superalloys that are strengthened by additives such as ceramics via laser power bed fusion (LPBF) manufacturing. Other manufacturing techniques can also be used, including but not limited to directed energy deposition, friction stir welding, and binder jetting. These materials can be useful in the production of components for use in extreme environments, such as for structural materials used in high-irradiation environments (e.g., exceeding approximately 0.5 displacement per atom (DPA) per year), like fusion reactors and/or advanced fission reactors, as well as for structural materials used in high-temperature environments (e.g., exceeding approximately 600° C.), like turbines.

One embodiment of a composition includes a Nickel-superalloy powder and additive particles of an additive powder. The Nickel-superalloy powder combines with the additive particles to form a plurality of composition particles of a composition powder. A volume percent of the Nickel-superalloy powder is approximately in a range of about 90 vol % to about 99.5 vol %. A volume percent of the additive particles is approximately in a range of about 0.5 vol % to about 10 vol %. An average diameter of each particle of the plurality of composition particles is about 40 μm or less, and a sphericity of a majority of particles of the plurality of composition particles is at least about 90% as compared to a perfect sphere.

A diameter of each particle of the plurality of composition particles can be less than about 100 μm. The Nickel-superalloy powder can be at least one of Inconel 718, CMSX-4 or Inconel 939. The additive particles can include ceramic additive particles that have at least one of silicon carbide, titanium diboride, zirconium diboride, hafnium carbide, tantalum carbide, hafnium diboride, tantalum diboride, tungsten disilicide, tantalum disilicide, or hafnium disilicide. In some embodiments, the Nickel-superalloy powder can include CMSX-4, and the ceramic additive particle can include titanium diboride. The additive particle can include pure Boron. In some embodiments, the Nickel-superalloy powder can include CMSX-4, and the additive particle can include pure Boron.

The composition can be formulated by at least one of mixing or blending the Nickel-superalloy powder with the ceramic additive particles to formulate the plurality of composition particles, and sieving the plurality of composition particles such that each particle of the plurality of composition particles has an average diameter that is about 40 μm or less. Further actions that can be performed to formulate the composition can include spreading the plurality of composition particles such that they have a substantially uniform thickness across a surface, and applying heat to the particles to formulate the composition.

A printed part can include the embodiment(s) of the composition discussed above. The printed part can be formed by laser powder bed fusion. In some embodiments, the printed part can be configured for use in at least one of a high-irradiation environment (e.g., fusion reactor, advanced fission reactor) or a high-temperature environment (e.g., exceeding approximately 600° C., turbines).

One method of formulating a metal matrix composition includes at least one of mixing or blending a Nickel-superalloy powder with additive particles to formulate a plurality of composition particles of a metal matrix composition, and sieving the plurality of composition particles such that each particle of the plurality of composition particles has an average diameter that is about 40 μm or less. The method further includes spreading the plurality of composition particles such that they have a substantially uniform thickness across a surface, and applying heat to the composition particles to formulate the metal matrix composition.

At least one of mixing or blending a Nickel-superalloy powder with additive particles can include ball milling the Nickel-superalloy powder with the additive particles. A diameter of each particle of the plurality of composition particles can be less than about 100 μm. In some embodiments, a sphericity of a majority of particles of the plurality of composition particles can be at least about 90% as compared to a perfect sphere. The Nickel-superalloy powder can include at least one of Inconel 718, CMSX-4, or Inconel 939. The additive particle can include pure Boron.

The additive particles can include ceramic additive particles that have at least one of silicon carbide, titanium diboride, zirconium diboride, hafnium carbide, tantalum carbide, hafnium diboride, tantalum diboride, tungsten disilicide, tantalum disilicide, or hafnium disilicide. In some embodiments, the Nickel-superalloy powder can include CMSX-4, and the ceramic additive particle can include silicon carbide. The Nickel-superalloy powder can include CMSX-4, and the ceramic additive particle comprises zirconium diboride.

One embodiment of an additive manufacturing printer includes a formulation chamber in which a material for printing is formulated, a platform configured to receive the formulated material from the formulation chamber, and a heating component configured to harden the formulated material in conjunction with printing a printed part.

The formulation chamber can be configured to have the composition of the composition(s) discussed above formulated in it. The additive manufacturing printer can be configured to print the printed part of the printed part discussed above. The additive manufacturing printer can be configured to have any of the methods discussed above performed in it. The methods of any of the claims discussed above can be performed in the formulation chamber of the additive manufacturing printer.

### BRIEF DESCRIPTION OF THE DRAWINGS

This disclosure will be more fully understood from the following detailed description taken in conjunction with the accompanying drawings, in which:

FIG. 1A is a scanning electron microscope (SEM) image of an embodiment of a ceramic powder used as an additive to form metal matrix compositions (MMCs);

FIG. 1B is a magnified SEM image of an individual In718 particle surface that is used as a base to form MMCs prior to being combined with the additive of FIG. 1A;

FIG. 1C is a magnified SEM image of a composite of the ceramic powder of FIG. 1A combined with the base of FIG. 1B and a magnified inset (ins) thereof;

FIG. 2A is a perspective view of the composite of FIG. 1C before removal from AISI 4140 Steel build plates;

FIG. 2B is a schematic illustration of an example embodiment of a room-temperature (RT) tensile specimen and its corresponding geometry and dimensions;

FIG. 2C is a schematic illustration of an example embodiment of a high-temperature tensile specimen and its corresponding geometry and dimensions;

FIG. 3A is an X-ray computed tomography (CT) reconstruction that display pores with diameters greater than about 20 μm formed during printing of the base of FIG. 1B;

FIG. 3B is an X-ray CT reconstruction that display pores with diameters greater than about 20 μm formed during printing of the composite of FIG. 1C;

FIG. 4 is a histogram that illustrates pore counts for undoped and reinforced samples organized by maximum feret diameter;

FIG. 5A is a high magnification of a scanning transmission electron microscope (STEM/EDX) mapping analysis focusing on an exchange reaction zone between Zr, B, Nb, Mo and Cr in a heat treated composite of FIG. 1C;

FIG. 5B is a high magnification STEM/EDX mapping analysis in the heat treated composite of FIG. 1C showing a high Nb signal;

FIG. 5C is a high magnification STEM/EDX mapping analysis in the heat treated composite of FIG. 1C showing a high B signal;

FIG. 5D is a high magnification STEM/EDX mapping analysis in the heat treated composite of FIG. 1C showing a high Mo signal;

FIG. 5E is a high magnification STEM/EDX mapping analysis in the heat treated composite of FIG. 1C showing a high Cr signal;

FIG. 5F is a high magnification STEM/EDX mapping analysis in the heat treated composite of FIG. 1C showing a high Ni signal;

FIG. 5G is a high magnification STEM/EDX mapping analysis in the heat treated composite of FIG. 1C showing a high Zr signal;

FIG. 6A is a graph illustrating room temperature tensile stress-strain curves of the base of FIG. 1B, the composite of FIG. 1C, an as-printed base of FIG. 1B, and an as-printed composite of FIG. 1C;

FIG. 6B illustrates a table listing sample number identifiers for several composite compositions of FIG. 1C printed using laser power bed fusion (LPBF) with and without heat treatment;

FIG. 6C is a graph illustrating a comparison of room temperature yield strength (σ_{YS}) and RT ultimate tensile strength (σ_{UTS}) of several In718 and In718-based composites printed using LPBF with and without heat treatment;

FIG. 6D is a graph illustrating a comparison of room temperature elongation (%) of several In718 and In718-based composites printed using LPBF with and without heat treatment;

FIG. 7 is a graph illustrating high-temperature tensile stress-strain curves for heat treated samples of the base of FIG. 1B and the composite of FIG. 1C;

FIG. 8A is an SEM image taken from a fractured surface of a heat treated sample of the base of FIG. 1B at room temperature;

FIG. 8B is an SEM image taken from a fractured surface of a heat treated sample of the base of FIG. 1B at 650° C.;

FIG. 8C is an SEM image taken from a fractured surface of a heat treated sample of the base of FIG. 1B at 850° C. having an inset that shows a magnified view of its fracture surface;

FIG. 8C is an SEM image taken from a fractured surface of a heat treated sample of the base of FIG. 1C at room temperature;

FIG. 8B is an SEM image taken from a fractured surface of a heat treated sample of the base of FIG. 1C at 650° C.;

FIG. 8C is an SEM image taken from a fractured surface of a heat treated sample of the base of FIG. 1C at 850° C. having an inset that shows a magnified view of its fracture surface;

FIG. 9 is a graph illustrating room temperature tensile stress-strain curves stress-strain curves of LPBF-optimized In939 and LPBF-optimized In939+TiB₂;

FIG. 10A illustrates cross-sectional SEM images of LPBF'ed samples of In939 under varying laser power and scan speed;

FIG. 10B illustrates cross-sectional SEM images of LPBF'ed samples of In939+TiB₂ under varying laser power and scan speed;

FIG. 10C is a graph illustrating the relative densities the samples of FIGS. 10A and 10B;

FIG. 11A is a chart illustrating yield strength curves of the LPBF-optimized In939+TiB₂ as compared to the LPBF-optimized In939;

FIG. 11B is a chart illustrating ultimate tensile strength curves of the LPBF-optimized In939+TiB₂ as compared to the LPBF-optimized In939;

FIG. 12A is a graph illustrating stress-strain curves for In939 and In939+TiB₂ at 800° C. and 850° C.;

FIG. 12B is a chart showing high-temperature yield and ultimate tensile strengths of In939+TiB₂ compared to other In939 alloy as reported in the literature;

FIG. 12C is a 50 μm magnified view of a fracture surface of In939 after testing at 800° C.;

FIG. 12D is a 10 μm magnified view of a fracture surface of In939 after testing at 800° C.;

FIG. 12E is a 50 μm magnified view of a fracture surface of In939+TiB₂ after testing at 800° C.;

FIG. 12E is a 10 μm magnified view of a fracture surface of In939+TiB₂ after testing at 800° C.;

FIG. 13 is a prior art chart illustrating weldability of Nickel based superalloy family applications of alloy design to cracking resistance of additively manufactured Ni-based alloys;

FIG. 14A is a cross-sectional SEM image showing defect distributions in CMSX-4 as a function of scanning speed and laser power; and

FIG. 14B is a cross-sectional SEM image showing defect distributions in CMSX-4+0.5 wt % pure B as a function of scanning speed and laser power.

### DETAILED DESCRIPTION

Certain exemplary embodiments will now be described to provide an overall understanding of the principles of the compositions, methods of manufacture, and related systems disclosed herein. One or more examples of these embodiments are illustrated in the accompanying drawings. Those skilled in the art will understand that the compositions, methods of manufacture, and related systems specifically described herein and illustrated in the accompanying drawings are non-limiting exemplary embodiments and that the scope of the present disclosure is defined solely by the claims. The features illustrated or described in connection with one embodiment may be combined with the features of other embodiments. Such modifications and variations are intended to be included within the scope of the present disclosure.

To the extent that linear or circular dimensions or shapes are used or described herein, such dimensions are not intended to limit the types of shapes or sizes of such particles, materials, devices, components, etc., unless otherwise indicated or understood by a person skilled in the art. Further, a person skilled in the art will recognize that an equivalent to such linear and circular dimensions or shapes can be easily determined for any geometric shape (e.g., references to widths and diameters being easily adaptable for circular and linear dimensions, respectively, by a person skilled in the art). Still further, to the extent features, sides, or steps are described as being “first,” “second,” etc., such numerical ordering is generally arbitrary, and thus such numbering can be interchangeable.

The present disclosure provides for novel formulations of superalloy MMC compositions and methods of making the same. For example, at least one novel aspect of the present disclosure includes an option for creating enhanced materials that will be able to withstand higher temperatures by utilizing harder, stiffer ceramic particle additions to allow the MMCs to achieve improvements in mechanical properties, physical properties, and more. MMC materials of the present disclosure may include a base metal that is coated with ceramic nanostructures, for example by mechanical milling, which can result in a final composite powder with good sphericity. In some embodiments, the final composite powder can include particle diameters approximately in the range of about 10 μm to about 100 μm. More particularly, the present disclosure can provide for nickel superalloys, such as Inconel 718, CMSX-4, and Inconel 939, as the base metal, and the use of several carbide, boride, and/or silicide ceramic reinforcements as an additive. These reinforcements may exhibit superior hardness, oxidation resistance, and/or chemical inertness at elevated temperatures, which have not been utilized in MMC formation with the described base metals prior to the present disclosure.

MMCs of the present embodiments can be produced by additive manufacturing (AM) technologies, also referred to as 3D printing. Laser powder bed fusion (LPBF) can be an example of an AM technique that can be a favorable method for producing metals and MMCs because it can provide certain advantages compared to conventional manufacturing. Some of the advantages as compared to the conventional methods can include reduction of post processing such as assembly, joining, etc., reduction in energy consumption and manufacturing costs, enabling weight reduction, and enhancing productivity while simplifying the production of complex parts, and lowering carbon dioxide emissions. The culmination of these described advantages and the inherent localization of the powder bed fusion (PBF) process can make it particularly well-suited for production of new MMC materials for high temperature applications.

Prior to the present disclosure, to the extent composite powder mixtures have been used in conjunction with AM processes, the mixtures have been prepared prior to use of the AM processes. Processes related to how the mixtures formulate and/or otherwise react with other components of the mixture can generally occur prior to implementing the AM processes. To the contrary, the present disclosure contemplates forming the mixtures in conjunction with performing AM processes, utilizing the laser melting process to alter the initial mixtures, and developing new phases in-situ. More particularly, the provided for diffusion and chemical reaction process of the present disclosure can be instigated, for example, by a laser, which can dissolve the original ceramics and form new phases, as discussed in greater detail below.

The present disclosure provides for the formation of metal matrix composites that include additives, such as ceramic additives, for use in additive manufacturing. A number of different techniques can be used to combine alloys with additives, including but not limited to mixing and/or blending. Once formulated, the resulting materials can be used in a variety of types of additive manufacturing. In some exemplary embodiments, a PBF additive manufacturing technique can be implemented to formulate parts with the resulting material. The resulting material can have exceptional properties for use in extreme environments, including but not limited to high-irradiation environments and/or high-temperature environments.

### Compositions

In general, the compositions provided for in the present disclosure can include Ni-superalloys (e.g., In718, In939, CMSX-4, and so forth) strengthened by ceramic additives to exhibit superior oxidation resistance and/or chemical inertness at elevated temperatures. One such example can use zirconium diboride (ZrB₂) as a reinforcing material. ZrB₂ has a relatively low density, has good mechanical properties, and is corrosion resistant. In some embodiments, the parts produced using ZrB₂ can include about 2 vol % ZrB₂ nanoparticle-reinforced In718 parts, which can be produced via laser power bed fusion (LPBF). As shown herein, the microstructural and mechanical characteristics of the ZrB₂ reinforced In718 parts evaluated under room temperature and high temperature conditions can be superior to unreinforced In718 parts prepared following the same procedure. Some additional non-limiting examples of ceramic reinforcement materials that can be used in conjunction with the present disclosure can include pure Boron (B), silicon carbide (SiC), titanium diboride (TiB₂), hafnium carbide (HfC), tantalum carbide (TaC), hafnium diboride (HfB₂), tantalum diboride (TaB₂), tungsten disilicide (WSi₂), tantalum disilicide (TaSi₂), and/or hafnium disilicide (HfSi₂), among other combinations of the same and/or other combinations of similarly performing materials. In some embodiments, a volume percent of the Nickel-superalloy powder of the present embodiments can be approximately in a range of about 90 vol % to about 99.5 vol %.

For example, when one or more of ZrB₂. SiC, and/or TiB₂ are used as ceramic reinforcement materials, the resulting compositions (e.g., Inconel 718+ZrB₂, Inconel 718+SiC, Inconel 939+TiB₂, CMSX-4+ pure B, CMSX-4+TiB₂) can be developed through mechanical mixing of powders followed by powder bed fusion. During a mechanical mixing step, about 98 vol % In718 or In939 and about 2 vol % ceramic mixture can be subjected to techniques such as ball milling to reduce particle size and enable cold-welding of the ceramic additives to the surfaces of the metal particles. A person skilled in the art, in view of the present disclosures, will appreciate other techniques can be used to reduce particle size and/or enable cold-welding. Sieving of the milled powders can be performed to ensure that particle sizes do not exceed, in at least some instances, approximately 100 μm in diameter, and scanning electron microscope (SEM) imaging can be used to confirm that average particle diameter is less than, in at least some instances, approximately 40 μm. It will be appreciated that while the compositions and techniques of the present embodiments are discussed below with respect to Inconel 718+ZrB₂, any of the bases and/or additives mentioned herein can be substituted for one or more of the In718 or the ZrB₂, with some of these combinations also being discussed below.

During the manufacturing step, the resulting powder can be utilized in a laser powder bed fusion process, whereby the powder is spread flat in predetermined layer thicknesses and rapidly laser-melted in specified regions to build components layer-by-layer based on digital models of the desired part. For example, this process can be utilized to produce millimeter-scale components of both the In718+ZrB₂, In718+SiC materials, CMSX-4+ pure B, and CMSX-4+TiB₂, among others, which can be large enough to enable testing of their mechanical properties. Room temperature tensile testing of the SiC-strengthened material can demonstrate an approximately 15% increase in yield strength and an approximately 12% increase in ultimate tensile strength over In718 material printed in equivalent conditions without the addition of SiC. Following an industry standard heat-treatment, the SiC-strengthened material can continue to demonstrate an approximately 10% increase in ultimate tensile strength. Analysis of the printed samples can suggest that the laser melting process may result in the breakdown of the SiC, which can be followed by the in-situ formation of silicide and carbide precipitates with the base metal elements. This process can be found to decrease grain size and result in printed parts with fewer pores and cracks, and it is believed that the improved strength resulted as a culmination of the decreased grain size, the decreased porosity, and the interaction of dislocations with the newly formed silicide and carbide precipitates. Production and testing of the ZrB₂ strengthened materials can show an increase of approximately 30% for yield strength and approximately 20% for ultimate tensile strength over the base In718 in the as-printed state.

The compositions can be formed by mixing, blending, or otherwise causing the two materials to combine. Before the materials are combined, or while or after they are combined, the particles forming the same can be treated to be small in size. Typically this means less than about 100 μm, with an average particle size of less than about 40 μm while still maintaining a spherical shape, referred to herein, and as understood by those skilled in the art, as maintaining sphericity. By way of example, the particles can be described as maintaining sphericity if they have at least a 90% sphericity as compared to a perfect sphere, as measured, for example, from SEM micrograph images, and as otherwise understood by a person skilled in the art. These particle sizes and shapes can be for one or both of the metal particles and the ceramic additives. The small particle sizes enable cold welding of the ceramic additives to the metal particles. The amount of ceramic additives can be in the range of about 0.5 percent by volume to about 10 percent by volume, and in some instances it can be about 2 percent by volume. The use of these ceramic nanoparticles can produce a unique phase transformation behavior with the metal particles.

### Printers

The compositions (base metal+additive) formulated in the present disclosure can be utilized in a variety of different printing techniques. As noted above, while LPBF can be the printing technique primarily discussed herein, other techniques, including but not limited directed energy deposition, friction stir welding, and binder jetting, can be used to print components out of the compositions provided for herein. Further, the present disclosure can also provide for the production of specialty printers that formulate the compositions directly in the printer and then utilize those formulated compositions as the material for printing. This may include, by way of non-limiting examples, a formulation chamber provided for in the printer in which the mixtures provided for herein and/or otherwise derivable from the present disclosure can be mixed or otherwise created and then used in conjunction with printing components. This can include retrofitting existing printers to create such a formulation chamber and/or changing a chamber of such existing printers to constitute the formulation chamber(s) contemplated herein, or the creation of a new printer that includes such a formulation chamber(s).

During printing, the diffusion and chemical reaction processes that can be instigated, for example, by sources such as a laser can cause the original additives (e.g., ceramics) to form new phases for the composition, and thus the part, being printed. Printers that utilize the compositions and/or methods provided for herein can provide for in-situ mixing and chemical reactions to occur within the printer and/or while printing. Examples of metal matrix compositions (MMCs) that include additives, and how they were formulated, are provided in the description of various experiments below.

### EXPERIMENTAL MATERIALS AND METHODS

### Feedstock Preparation

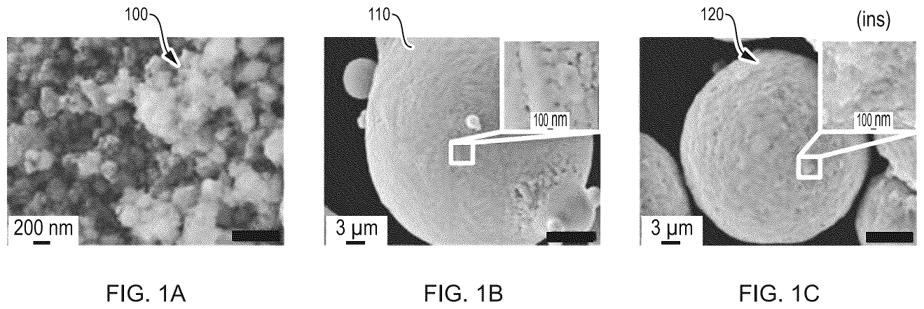

A ZrB₂ nanoparticle reinforced In718-based metal matrix composite can be successfully fabricated via LPBF technique. For example, Inconel 718 (In718) powders from MSE Supplies LLC (Tucson, AZ, USA) can serve as a foundational portion of the composition, with the additive being ZrB₂ powders, though it will be appreciated that one or more of the base and/or the additive can be changed. FIGS. 1A-1B illustrate a scanning electron microscope (SEM) image, also referred to as an SEM micrograph, of a commercial ZrB₂ powder 100 for use as an additive and a zoomed-in SEM image of an individual In718 particle 110 for use as a base, respectively, whose surface is shown prior to being combined with any additive, and thus prior to any blending with an additive. It will be appreciated that ZrB₂ powders 100 with particle diameters less than about 100 nm from US Research Nanomaterials Inc. were used as the additive. The SEM image of FIG. 1A can be used to confirm that the ZrB₂ powders, which in at least some instances can be blended and/or ball-milled, can be agglomerated and have particle sizes below about 100 nm.

The ceramic powders 100 of FIG. 1A when combined with the In718 powders 110 of FIG. 1B can form an In718 mixture 120 or a composite sample of about 2 vol % ZrB₂, as illustrated in FIG. 1C. Specifically, FIG. 1C is a zoomed in SEM micrograph of individual In718 particle surfaces with the surfaces now having the ZrB₂ additive attached thereto. The combination of the ceramic powders 100 and the In718 powders 110 can be achieved using a variety of blending or mixing techniques. In the illustrated embodiment, the powders were blended in batches of about 500 grams in a high-speed blender (e.g., blender model VM0104 from Vita-Mix, USA) for about 90 minutes.

A particle size of the mixture 120 can vary. For example, in some embodiments, the commercial In718 powders can have particle sizes approximately in the range of about 15 μm to about 45 μm. The In718 powders 120 can retain their sphericity after mixing with sub-micron ZrB₂ powders 110. That said, a person skilled in the art will recognize that the surface texture of the commercial In718 powder 110 prior to treatment, as shown in FIG. 1B, differs from the mixture of FIG. 1C, with the powder 110 having dendritic grains instead of decorated nanoparticles.

EDX results comparing regions of FIGS. 1B and 1C are also presented in Table 1, below, and confirm that the surface of the In718 particles 110 can be effectively decorated with ZrB₂ powder 100 after high-speed blade mixing.

TABLE 1

| | | | Average view of large |
|---|---|---|---|
| Element | | | number of particle |
| (wt %) | FIG. 1B | FIG. 1C | surfaces |
| Ni | 52.49 | 49.88 | 45.03 |
| Fe | 19.97 | 20.29 | 18.17 |
| Cr | 17.21 | 21.00 | 18.08 |
| Nb | 4.75 | 3.79 | 3.11 |
| Mo | 2.90 | 3.17 | 3.19 |
| Ti | 0.89 | 1.10 | 1.02 |
| Co | 0.95 | 0.11 | 0.17 |
| V | 0.73 | 0.03 | 0.01 |
| Mn | 0.11 | 0.03 | 0.01 |
| Zr | — | 0.44 | 7.08 |
| B | — | 0.02 | 3.87 |

More particularly, Table 1 illustrates EDX results obtained from the surface of an In718 particle 110 before blending, as shown in FIG. 1B, the surface of the In718 particle after blending, as shown in FIG. 1C, and from an average view of a large number of particle surfaces after blending, respectively. The confirmed distribution of the ceramic on individual metal particles observed here can contribute, often in a significant manner, to the homogeneous distribution of the additives in the final printed part, which can be a key advantage of the methods disclosed herein as compared to traditional manufacturing methods.

### Laser Powder Bed Fusion (LPBF) and Heat Treatment Process

After creating the blade-mixed 2 vol % ZrB₂ reinforced In718 composite powders 120, such powders can be compared to unreinforced In718 powders in terms of their ability to perform when serving as a material being printed by way of additive manufacturing. In the present case, the additive manufacturing technique of laser powder bed fusion (LPBF) was used, with an M290 metal 3D printer by EOS (Germany) being the testing printer. The parameter set was determined based on data from previously published LPBF studies of In718. Table 2, shown below, depicts the LPBF process parameters applied to both the In718 sample 110 and 2 vol % ZrB₂ reinforced In718 composite samples 120 (hereinafter referred to as In718+ZrB₂).

TABLE 2

| | |
|---|---|
| Laser power (W) | 285 |
| Scanning speed (mm/s) | 960 |
| Layer thickness (μm) | 40 |
| Hatch spacing (μm) | 110 |
| Laser spot size (μm) | 100 |
| Scan rotation (°) | 67 |

Although the LPBF was the printing technique used, a person skilled in the art, in view of the present disclosures, will appreciate other manufacturing techniques can also be used, including but not limited to directed energy deposition, friction stir welding, and binder jetting.

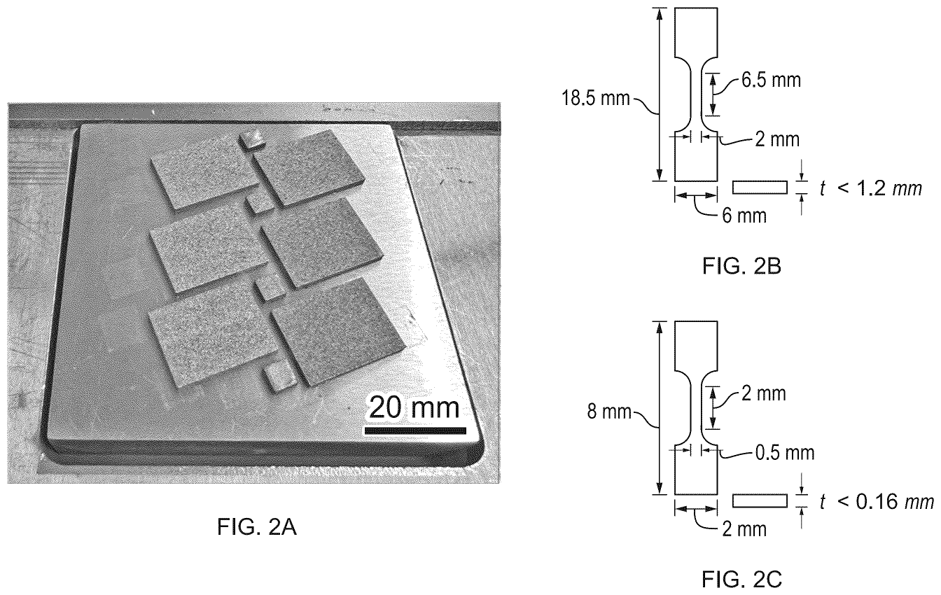

FIG. 2A displays In718+ZrB₂ before removal from AISI 4140 Steel build plates. Both room-temperature (RT) and high-temperature tensile specimens and their corresponding geometry and dimensions are also shown in FIGS. 2B and 2C, respectively. Both specimens were machined by a wire electrical discharge machine (EDM), though other manufacturing methods are possible and known by one skilled in the art.

Following removal from the build plate by wire electron discharge machining, samples of both the reinforced 110 and unreinforced In718 materials 120 were subjected to a standard heat treatment that is applied for wrought In718, performed in a tube furnace (e.g., OTF-1200X). The heat treatment parameters performed on the samples are described in Table 3 below.

TABLE 3

| Heat Treatment Steps | Heat Treatment Conditions |
|---|---|
| Step 1 | 1050° C./15 min, water cooling |
| Step 2 | 720° C./8 h, furnace cooling |
| Step 3 | 620° C./8 h, air cooling |

To the extent the present disclosure discusses heat treatments, a person skilled in the art, in view of the present disclosures, will understand such heat treatments can involve the action of heating and/or applying energy. A person skilled in the art will also appreciate many different forms that such actions of heating and/or applying energy can involve, including but not limited to melting and/or laser melting, for instance when LPBF is involved in the process of forming the composition(s).

### Materials Characterization

Samples of the powder 110 (FIG. 1B) and the composite 120 (FIG. 1C) can be cut, ground, mechanically polished, and/or chemically etched prior to characterization experiments. This can help normalize the samples with respect to each other. The phase composition of LPBF processed samples can be characterized by X-ray diffraction using Cu Kα (λ=0.154 nm) radiation over the range of scattering angles between 2θ=10-90° (e.g., Malvern Panalytical Ltd, Malvern, UK). To determine the microstructural characterization and chemical composition, a Zeiss Merlin high-resolution SEM (e.g., Carl Zeiss AG, Oberkochen, Germany) was used. Electron backscatter diffraction (EBSD) analyses were performed in the same SEM. A Zeiss Vision 40 CrossBeam Focused Ion Beam (FIB) was utilized to prepare samples for transmission electron microscopy (TEM). Following FIB, transmission electron microscopy (TEM) was carried out in a JEOL 2010F Field emission STEM (e.g., JEOL Ltd., Tokyo, Japan) at 200 kV. Porosity quantity and distribution for printed samples were analyzed via computed tomography (CT) in a Zeiss Xradia 620 Versa x-ray microscope. Vickers hardness values of the LPBF processed samples were obtained from indentation tests using a Struers/Emco-Test DuraScan Automatic Hardness Tester (Struers LLC, Cleveland, OH, USA) under a load of 0.5 kg (4.903 N) for 10 seconds. Ten (10) successive indentations were carried out for all the samples and the average Vickers hardness values with their standard deviations were reported. Tensile tests were performed at room temperature in an Instron 5969 with a strain rate of 2×10⁻⁴ s⁻¹ and repeated three times for each sample category to verify results. The tensile displacement and the strain were precisely recorded by a non-contact AVE2 video extensometer. High temperature tensile tests were performed at 650° C. and 800° C. with a 2×10⁻⁴ s⁻¹ strain rate in an Instron 8841 (load cell capacity 1 kN) equipped with a furnace operating up to 1000° C.

### Testing

After fabrication of the In718 110 and In718+ZrB₂ composites 120, SEM/EDX analysis was performed on as-printed and heat treated samples. Microstructures of as-printed and heat treated In718 samples 11—can show spherical porosities. These porosities can be believed to be gas porosities, which may have formed during LPBF. The related porosities were not observed in the In718+ZrB₂ composites 120, despite being printed using LPBF under the same conditions optimized for unreinforced In718. These findings suggest that the incorporation of ceramic nanofillers, such as the ZrB₂ additive, may reduce the formation of defects associated with the printing process. It was also noted that the grain size of the In718+ZrB₂ samples 120 were strikingly lower compared to those of undoped In718 samples 100 independent of being heat treated.

Laves phases can be formed in the In718 matrix, with their corresponding elemental distributions listed in Table 4 (EDX point 1 and 3) below.

TABLE 4

| | | | | | General EDS |
|---|---|---|---|---|---|
| | | | | | obtained from |
| Element | | | | | as-printed |
| (wt %) | Point 1 | Point 2 | Point 3 | Point 4 | In718 + ZrB₂ |
| Ni | 53.85 | 37.46 | 52.37 | 37.63 | 51.68 |
| Fe | 19.82 | 9.87 | 18.23 | 7.98 | 18.15 |
| Cr | 18.12 | 1.94 | 19.75 | 1.12 | 18.44 |
| Nb | 10.39 | — | 10.13 | — | 4.58 |
| Ti | 0.93 | — | 0.72 | — | 0.7 |
| Al | 0.7 | — | 0.48 | — | 0.89 |
| Mn | 0.05 | — | 0.13 | — | 0.08 |
| Si | 0.36 | — | 0.35 | — | 0.37 |
| Mo | 7.51 | — | 8.55 | — | 2.73 |
| Zr | 0.19 | 52.88 | 0.21 | 51.11 | 1.84 |
| B | 0.08 | 0.11 | 0.08 | 0.16 | 0.54 |

Table 4 provides EDX analysis that shows high wt % concentrations of Nb and Mo confirmed the existence of Laves phases in the microstructure. Additionally, fine dark spots can occur. Such spots, which can have diameters less than approximately 100 nm, can be scattered over the matrix of as-printed and heat treated In718+ZrB₂ samples. EDX analysis obtained from points 2 and 4 showed that these dark spots were enriched with Ni and Zr but lacked B. This observation suggests a possible decomposition of ZrB₂ during LPBF. EDX mapping results obtained from In718+ZrB₂ samples 120 also clearly confirmed the presence of small Zr-rich particles distributed throughout the In718 matrix.

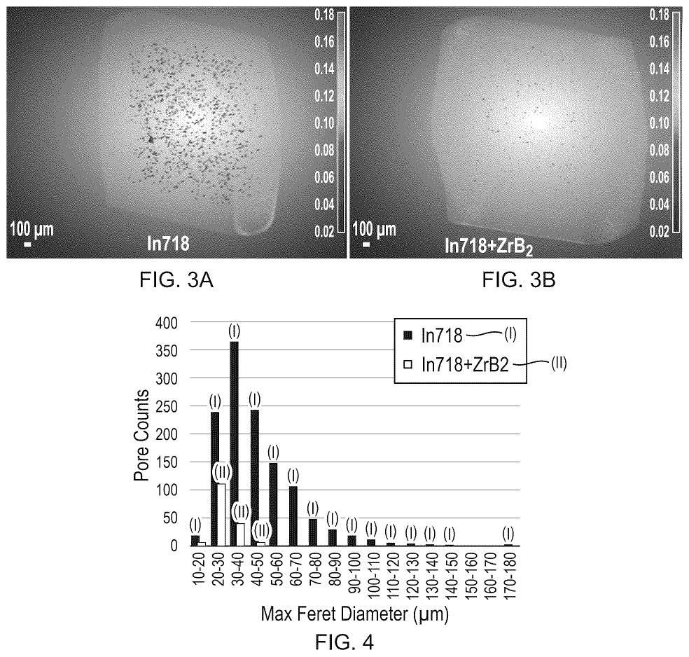

FIGS. 3A-3B illustrate an X-ray computed tomography (CT) analysis was performed on samples of as-printed In718 and In718+ZrB₂, to perform a more in-depth analysis on the porosity formation during printing. More particularly, FIG. 3A provides for x-ray CT reconstructions that display pores with diameters greater than about 20 μm formed during printing of In718, FIG. 3B provides for x-ray CT reconstructions that display pores with diameters greater than about 20 μm formed during printing of In718+ZrB₂ samples 120, and FIG. 4 provides a histogram of pore counts for undoped (A) and reinforced samples (B) organized by maximum feret diameter.

Results were taken from central regions more than 150 μm from each sample face to avoid edge effects of printing or EDM. Utilizing the previously described laser parameters that were based on literature optimization of undoped In718, CT results indicated that the In718 sample achieved approximately 99.90% density, with approximately 95% of pores having diameter less than about 90 μm and the largest pore having diameter of approximately 180 μm. On the other hand, the addition of about 2 vol % ZrB₂ was found to increase density to greater than 99.99% and decrease pore size such that approximately 95% of pores had diameters of less than 40 μm and a maximum pore diameter was found to be less than 50 μm, confirming the improvement in print quality observed under SEM for the reinforced sample (II) as compared to the undoped sample (I).

The significant decrease in as-printed porosity with ceramic reinforcement may be able to be explained by the formation of a ceramic coating on the surface of the metal particles decreasing laser reflection off the particle surfaces and thereby increasing energy absorption for more uniform melting. Another factor which is expected to have played a role is that the addition of ceramic particles may have increased the viscosity of the melt pool and decreased spattering during laser melting, resulting in fewer unmelted particles disrupting solidification. Decomposition of ZrB₂ during LPBF can be followed by a series of chemical reactions between several elements (i.e., Ni, Zr, B, Nb, Mo, Cr) forming intermetallic compounds and complex borides. In some embodiments, decomposition can result in formation of (Zr,Ni)-based intermetallic nanoparticles (below 100 nm) whereas other regions can show the existence of (Nb, Mo, Cr)-rich boride nanoparticles (between 100-200 nm). In other words, it could be stated that the free B can diffuse into boride forming elements (Nb, Mo, Cr) to form complex borides, while the free Zr can react with neighboring Ni elements during LPBF to form (Zr,Ni)-based intermetallics. It can be important to note that the (Zr,Ni)-based intermetallics are well-known for their thermodynamic and mechanical stability and this makes them a great dispersion strengthening constituent in alloy systems. This was confirmed after comparing the high temperature tensile properties of pure In718 and In718+ZrB₂, which is discussed in greater detail below.

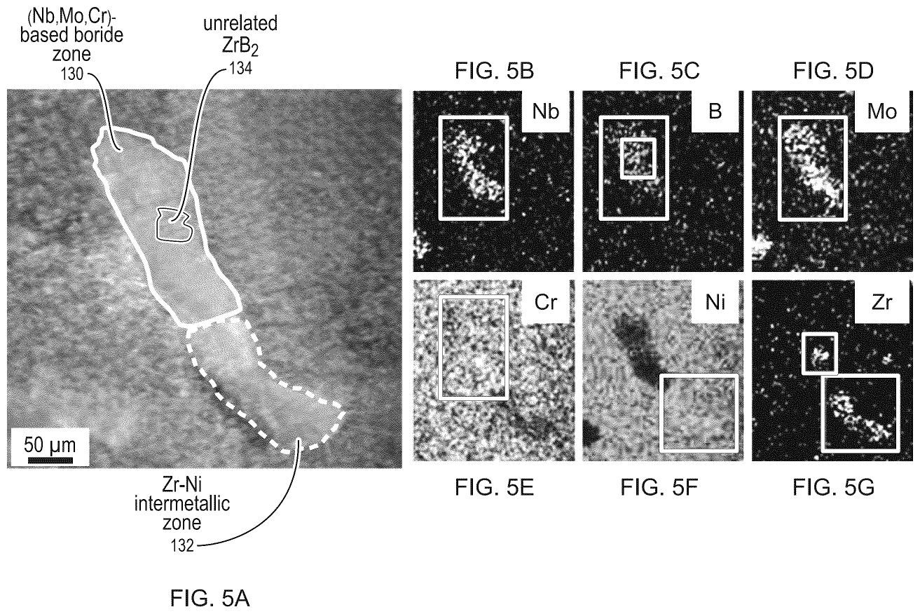

FIG. 5A displays a high magnification scanning transmission electron microscope (STEM/EDX) mapping analysis focusing on an exchange reaction zone between Zr, B, Nb, Mo and Cr in heat treated In718+ZrB₂. Three different phase zones are observable in FIG. 5, and the corresponding EDX results of the related phase regions are also listed in Table 5, below.

TABLE 5

| Element | (Nb, Mo, Cr)-based | Unreacted ZrB₂ | Zr—Ni intermetallic |
|---|---|---|---|
| (wt %) | boride zone | zone | zone |
| Ni | — | 0.39 | 46.18 |
| Fe | — | 0.12 | 1.26 |
| Cr | 20.60 | 0.17 | 1.49 |
| Nb | 27.54 | — | — |
| Mo | 22.83 | — | — |
| Zr | — | 86.40 | 51.07 |
| B | 29.03 | 12.92 | — |

With reference to FIG. 5A, the region 130 can be rich in Nb, Mo, Cr and B elements, shown in FIGS. 5B-5E, indicating the formation of (Nb,Mo,Cr)-based complex borides. Meanwhile, phase region 132 located adjacent to the (Nb,Mo,Cr)-based boride region can show high Zr and Ni signals, shown in FIGS. 5F-5G. This supports that the (Nb,Mo,Cr)-based boride region 130 was promoted by free B released by decomposition of ZrB₂ nanoparticles during LPBF. Furthermore, a ZrB₂ region 134 of unreacted ZrB₂ was detected in the middle of the (Nb,Mo,Cr)-based boride particle, further supporting the assumption that the decomposition of the ZrB₂ nanoparticles was the reason behind formation of (Nb,Mo,Cr)-based boride and (Zr,Ni)-based intermetallic nanoparticles during LPBF.

EBSD orientation maps of each sample can reveal significant grain size reduction, especially in as-printed In718+ZrB₂ composites 120. Incorporation of the fine ceramic borides can hinder grain growth of alloys during solidification if they are homogeneously distributed in liquid metal. Therefore, this finding can confirm that ZrB₂ also has a high potential to produce fine-grained nickel-based metal matrix composites via LPBF. Another striking result was the remarkable difference in grain misorientation distributions between undoped and ZrB₂ doped samples after LPBF, in that the fraction of the low angle grain boundaries was lower in the as-printed In718+ZrB₂ samples compared to the as-printed In718, although the grain misorientation angle distributions became closer between undoped and ZrB₂ doped ones after heat treatment. Nevertheless, it will be appreciated that the thermal stresses during LPBF of In718 can cause a greater fraction of high dislocation density regions and facilitate the formation of low-angle grain boundaries. This was also a promising result, as it suggests that the ZrB₂ is diminishing thermal stress accumulation during LPBF, and thus has significant potential to contribute to the production of crack-free complex geometry parts via LPBF.

After interpreting the microstructural features, mechanical tests were carried out to understand the rate of enhancement in the performance of ZrB₂ doped In718 composites. Microhardness results of as-printed and heat treated In718+ZrB₂ were 476 and 576 HV, respectively, as illustrated in Table 6 below, which illustrates average microhardness of as-printed In718, heat treated In718, as-printed In718+SiC, and heat treated In718+SiC samples. In other words, microhardness was increased by 43% in as-printed condition and 24% in heat treated condition by doping ZrB₂ into In718. The microhardness values are also remarkably higher than those of In718+SiC composites. It is apparent that the existence and homogeneous distribution of (Zr,Ni)-based intermetallic and (Nb, Mo, Cr)-based boride nanoparticles in the matrix, lower porosity rate, and fine grain size distribution of In718+ZrB₂ resulted in exceptional microhardness values compared to pure In718.

TABLE 6

| Material | Microhardness value (HV) |
|---|---|
| In718 as-printed [53] | 319.1 ± 7.9 |
| In718 HT'ed [53] | 436.3 ± 11.3 |
| In718 + SiC as-printed [53] | 363 ± 10.2 |
| In718 + SiC HT'ed [53] | 468.9 ± 8.7 |
| In718 + ZrB₂ as-printed (this study) | 475.7 ± 13.0 |
| In718 + ZrB₂ HT'ed (this study) | 576.2 ± 10.6 |

Electron microscopy analysis revealed the decomposition of ZrB₂ into Zr and B elements. This decomposition resulted in the in-situ formation of (Zr,Ni)-based intermetallic and (Nb, Mo, Cr)-based boride nanoparticles, which were homogeneously distributed in In718 matrix. It is concluded that the in-situ formation of nanoparticles hampered grain growth during solidification. As a result, In718+ZrB₂ composites possessed significantly lower grain size distribution than the pure In718 after LPBF. In parallel, x-ray CT of ZrB₂ doped composites showed both an increase in as-printed density and a decrease in pore diameters compared to as-printed In718. This result is expected to relate to a slight increase in absorption which was observed with the addition of ZrB₂, but it may also be related to changes in melt pool viscosity resulting in decreased spatter during printing.

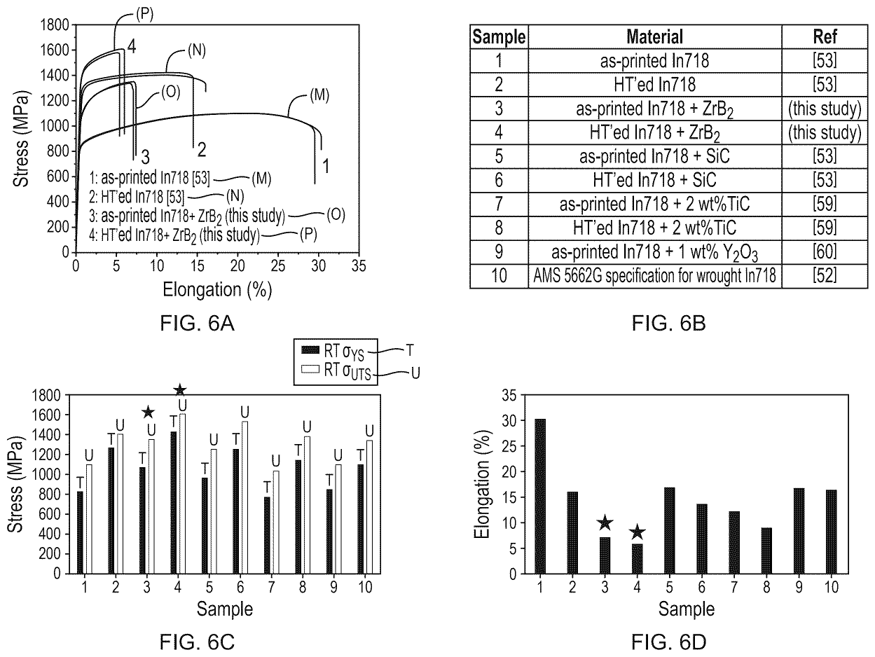

FIG. 6A shows room temperature tensile stress-strain curves of pure In718 110 and In718+ZrB₂ 120. As illustrated, RT yield strength (σ_{YS}) and RT ultimate tensile strength (σ_{UTS}) of the as-printed In718+ZrB₂ (curve O) were found to be significantly higher than as-printed pure In718 (curve M). However, the RT tensile elongation of the same sample was below 10%, which was low compared to the as-printed In718 (around 30%). RT σ_{YS} and RT σ_{UTS} of heat treated (HT) In718+ZrB₂ (curve P) increased by approximately 13% and approximately 15% respectively compared to its as-printed condition (curve N), while RT elongation of the heat treated ZrB₂ further decreased to about 5%.

FIG. 6B provides a table listing sample number identifiers for several In718 composite compositions printed using LPBF with and without heat treatment. These samples are then compared to the results of the present study in terms of RT mechanical properties in FIGS. 6C-6D. More particularly, FIG. 6C illustrates a comparison of room temperature σ_{YS} (curve T) and RT σ_{UTS} (curve U) of several In718 and In718-based composites printed using LPBF with and without heat treatment, while FIG. 6D illustrates a comparison of room temperature elongation (%) of several In718 and In718-based composites printed using LPBF with and without heat treatment. As shown, In718+ZrB₂ samples printed using LPBF showed remarkably higher strength but relatively lower elongation rate compared to similar composite samples printed using LPBF independent from heat treatment. The exceptional RT σ_{YS} and RT σ_{UTS} of In718+ZrB₂ samples 120 can suggest that the related intermetallic and (Nb,Mo,Cr)-based boride nanoparticles can play a critical role in enhancing RT mechanical properties, both in terms of their own strengthening effects from interactions with dislocations, and in terms of their effects on the grain size distribution and lower porosity rate observed in the In718+ZrB₂ samples compared to the pure In718. It will be appreciated that the bars of the graph having a “star” symbol indicate the LPBF-optimized samples.

High temperature tensile performance of the heat treated In718 and In718+ZrB₂ was tested at 650° C. and 800° C., separately. A temperature of 650° C. is considered to be the upper temperature limit for long-term structural usage of In718 by persons skilled in the art. On the other hand, HT tensile tests were also performed at an extreme temperature of 800° C. to understand the endurance limit of the novel In718+ZrB₂ composite 120.

Table 7 below provides for high-temperature tensile test results obtained from heat treated In718 and In718+ZrB₂ samples.

TABLE 7

| Sample | HT'ed In718 | HT'ed In718 + ZrB₂ |
|---|---|---|
| 650° C. σ_{YS} (MPa) | 963 | 1076 |
| 650° C. σ_{UTS} (MPa) | 1008 | 1162 |
| 650° C. Elongation (%) | 2.1 | 1.8 |
| 800° C. σ_{YS} (MPa) | 551.3 | 589.2 |
| 800° C. σ_{UTS} (MPa) | 576.2 | 603.1 |
| 800° C. Elongation (%) | 1.1 | 9.4 |

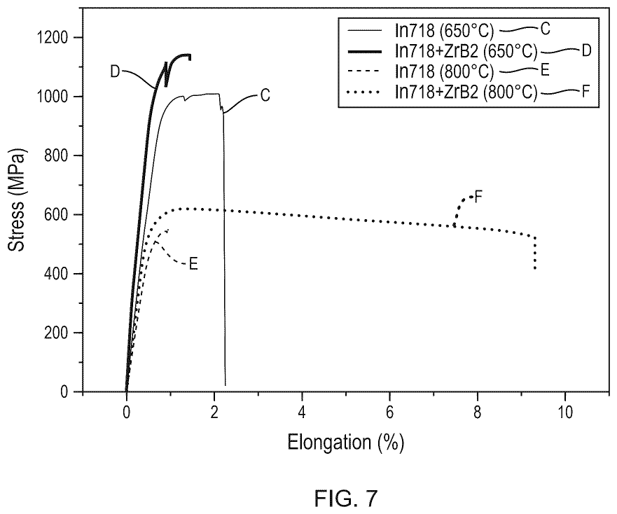

Relatedly, FIG. 7 illustrates high-temperature tensile stress-strain curves for heat treated In718 and In718+ZrB₂ samples. As shown in both Table 7 and FIG. 7, the achieved σ_{YS} (1008 MPa) and σ_{UTS} (1162 MPa) of In718+ZrB₂ (curve D) as approximately 15% higher than pure In718 at 650° C. (curve C). Further, elongation at failure of the pure In718 and In718+ZrB₂ were very close to each other at 650° C. (2.1 and 1.8%, respectively), showing that the ZrB₂ doping into In718 led to enhancement in strength with a low loss of ductility at 650° C. Meanwhile, elongation of the heat treated In718+ZrB₂ at 800° C. (curve F) increased considerably to almost 10%, remarkably higher than the pure In718 (curve E), which was found to slightly decrease in ductility to an elongation at failure of 1.1% with the further increase in temperature. This behavior is a complete reversal of the trends established from RT and 650° C. tensile results, where the inclusion of ZrB₂ was always found to result in loss of ductility. Low ductility accompanied by a sharp drop in strength is within expectations for In718 because this temperature regime is far above traditional In718 operation temperature limit. However, heat treated In718+ZrB₂ seemed to retain and even expand its ductility at extreme temperatures. Further, even with the increased ductility the σ_{YS} and σ_{UTS} at 800° C. for In718+ZrB₂ were found to be almost identical to pure In718 exposed to the same tensile testing conditions, indicating that a large increase in toughness and ductility were achieved without any loss in strength.

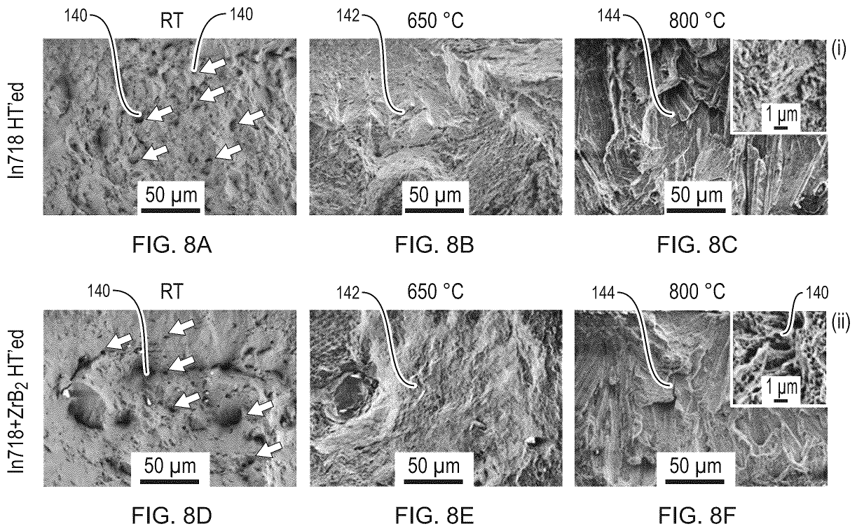

FIGS. 8A-8C and FIGS. 8D-8F show SEM images taken from a fractured surface of heat treated In718 and In718+ZrB₂, respectively, with the images being taken for different temperatures of tensile tests (e.g., room temperature (FIGS. 8A and 8D), 650° C. (FIGS. 8B and 8E), and 800° C. (FIGS. 8C and 8F), respectively). Fracture surfaces belonging to RT tensile specimens of heat treated In718 and In718+ZrB₂ show dimples and porosities 140 (annotated by arrows) indicating a ductile fracture mechanism (see FIGS. 8A and 8D). When the tensile test was performed at 650° C., fracture surfaces of both samples displayed brittle fracture morphology 142, which is consistent with low elongation rates (1-2%) observed in heat treated In718 and In718+ZrB₂ (see FIGS. 8B and 8E). When the tensile test was performed at 800° C., fracture surface of heat treated In718 showed remarkable and sharp cleavage planes 144 revealing that brittle fracture had once again taken place (see FIGS. 8C and 8F). However, heat treated In718+ZrB₂ showed dimples on its fracture surface after the 800° C. tensile test, as shown in the inset (ii), where heat treated In718 did not, as shown in inset (i).

As a result of the microstructural changes described, both RT and high temperature mechanical properties of In718+ZrB₂ composites were found to be exceptional compared to the pure In718, both as-printed and heat-treated. The enhancement in strength of ZrB₂ doped composites was due, at least in part, to a combination of different strengthening mechanisms, including grain size refinement and dispersion strengthening. Specifically, the heat treated In718 reinforced by ZrB₂ showed an approximately 15% increase in σ_{YS} and σ_{UTS}, though with significant loss in ductility (approximately 5% tensile elongation) compared to the undoped In718. High-temperature tensile results were found to be more remarkable. At 650° C. tensile testing temperature, In718+ZrB₂ achieved approximately 15% higher strength than pure In718 with almost identical elongation rate. Furthermore, the ZrB₂ doped composite was found to increase in ductility when the temperature was raised to 800° C. achieving almost 10% elongation with almost identical strength compared to the pure In718, which further decreased in ductility to approximately 1% elongation. These results suggest that the formation of a metal matrix composite with ZrB₂ may increase the high-temperature survivability of In718 and potentially raise upper operating temperature limits in systems where In718 components are currently employed. Thus, the scalable production method for In718+ZrB₂ composites shown in this study holds great potential for manufacturing components to be used in extreme environments such as nuclear fusion reactors and gas-turbine engines, among other uses.

### Advantages and Improvements

When ceramic powders are used, such as SiC, the results with In718+SiC demonstrate a superior overall combination of tensile properties, achieving increases in strength beyond that demonstrated with similar quantities of additives that may have been previously implemented, all while maintaining better elongation, suggesting an overall more survivable material. Results with ZrB₂ also suggest even further improvements in strength, with elongation that remains on par with results for additives that may have been previously implemented. Further, as additively manufactured metal matrix composites become adopted for more industrial uses, the availability of a variety of additives will be vital to provide tailoring of properties and chemical compatibilities. Still further, the powders that result from the present compositions are spreadable such that they can be swapped in for other instances in which a powder may otherwise be used in an additive manufacturing process. In718 and In939 composites with SiC and ZrB₂, among other compositions contemplated herein or otherwise derivable from the present disclosures, are combinations that may be especially useful in extreme environment fields that have not yet been introduced as market options.

### Commercial Applications

Currently identified potential markets for these materials are in the nuclear and aviation industries. To the extent Inconel components are utilized in these fields, they are difficult to use in extreme environments. The materials and techniques disclosed herein can provide improvements in strength and are expected to provide improvements in high-temperature survivability compared to the currently utilized materials. This can be of great economic benefit. For example, such improvements can decrease necessary component thickness and weight, resulting in lower material costs and lower fuel requirements. Improved high-temperature survivability can also allow for increases in operating temperature, improving the power generation efficiency in both fields. The present disclosure allows for 3D printing improved-property components for nuclear and aviation uses, among others.

### Additional Exemplary Compositions

Various features, embodiments, and compositions discussed above with respect to In718 can be combined and/or may apply to compositions beyond what is illustrated above. For example, another exemplary composition provided for herein can use Inconel 939 (In939) as the foundation or base metal with which additives discussed above are mixed, blended, or otherwise combined. In the present instance, the additive can be the ceramic titanium diboride (TiB₂), though it will be appreciated that In939 can be combined with any of the additives of the present disclosure. In939+TiB₂ can be formulated using similar techniques as those described above with respect to In718. Prior to the present disclosures, the use of In939 in combination with TiB₂ had not been achieved. For example, TiB₂-reinforced In939-based metal matrix composite can be successfully fabricated via LPBF. Electron microscopy analysis can reveal that the decomposition of TiB₂ upon melting resulted in the formation of (Cr)-based boride nanoparticles, which can be homogeneously distributed within the In939 matrix. Specifically, the formation of nanoparticles hampered grain growth during solidification, can lead to significantly smaller grain size distribution in In939+TiB₂ compared to pure In939. X-ray CT of TiB₂-doped composites can demonstrate the absence of cracks compared to the as-printed In939 under optimized LPBF conditions, as discussed in greater detail below. LPBF-optimized In939 reinforced by TiB₂ can exhibit nearly doubled σ_{YS} and σ_{UTS} compared to the undoped In939, while maintaining good ductility (13-15% tensile elongation). Moreover, the superior strength of LPBF-optimized In939+TiB₂ can be confirmed at high temperatures of 800° C. and 850° C. compared to other additively manufactured and conventional In939. The strengthening mechanisms contributing to the superior strength of In939+TiB₂ composites include grain boundary strengthening, solid solution strengthening, strengthening effect induced by CTE mismatch, dispersion strengthening, and compositional microsegregation strengthening.

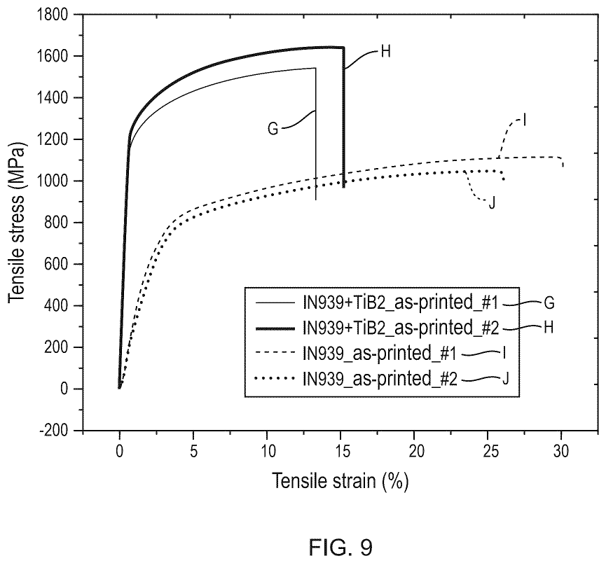

FIG. 9 illustrates a resulting tensile curve, akin to the one illustrated FIG. 6A comparing the stress-strain curves of pure (as-printed) In718 (curves I and J) and In718+ZrB₂ (curves G and H). The tensile curve shows acceptable room temperature tensile properties for In939+TiB₂ as compared to pure In939.

In testing, In939, which can be the base metal that is used in place of the In718, has shown improvement in tensile performance and crack elimination. Notably, the techniques of the present embodiments can achieve improvement in strength and high temperature durability, and the present compositions and methodology improve printability and decrease/eliminate solidification cracking, particularly with regards to low-weldability materials. For example, microstructural analysis of the as-printed specimens can reveal that Inconel 939+TiB₂ can eliminate crack formation under all LPBF conditions tested. Moreover, the as-printed In939+TiB₂ can exhibit superior room temperature (RT) yield strength (1,256 MPa) (curve G) and ultimate tensile strength (1578 MPa) (curve H) with reasonable tensile ductility (13-15%) compared to the as-printed In939 (curves I and J, respectively). Further still, In939+TiB₂ can possess exceptional high-temperature strength, demonstrating superior performance up to about 850° C. in contrast to other additively manufactured and cast In939 materials.

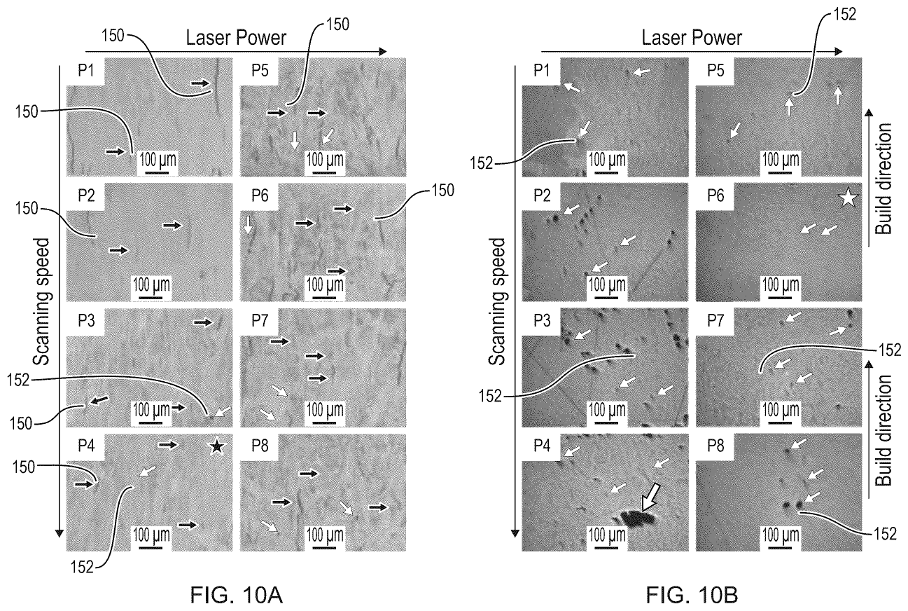

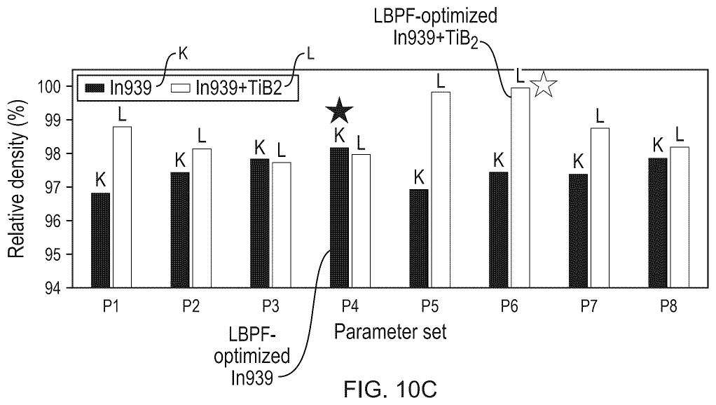

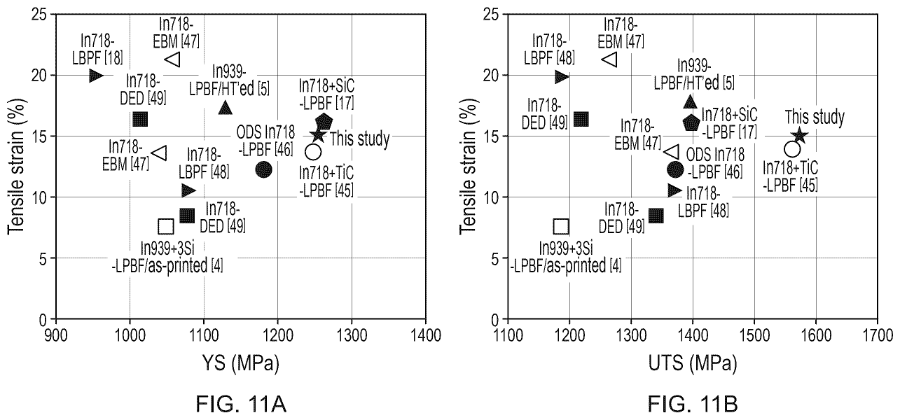

FIGS. 10A-10B illustrate SEM images of LPBF'ed samples of (a) In939 and (b) In939+TiB₂ under varying laser power and scan speed, respectively. The images demonstrate that the addition of TiB₂ particles notably inhibits cracking, as evident in the cross-sectional SEM images, with cracks 150 and porosities 152 being highlighted using the arrows pictured therein.

FIG. 10C is a graph illustrating the relative densities of all of the samples, e.g., In939 (K) and In939+TiB₂ (L). As noted above, the bars of the graph having a “star” symbol indicate the LPBF-optimized sample.

The LPBF-optimized In939+TiB₂ sample can have more than about 50% lower susceptibility to hot cracking compared to LPBF-optimized In939. Moreover, the addition of the TiB₂ can significantly improve tensile strength in In939 with a satisfactory fracture strain (about 13 to about 15%). Accordingly, the average hardness can be observed to be 354 HV for LPBF-optimized In939 and rise to 535 HV for LPBF-optimized In939+TiB₂, indicating a ˜50% increase in hardness for the composite.

FIGS. 11A-11B illustrate yield strength curves and ultimate tensile strength curves of the LPBF-optimized In939+TiB₂ as compared to the LPBF-optimized In939. As shown, LPBF-optimized In939+TiB₂ shows a doubling of the yield strength (oYs) and ultimate tensile strength (OUTS) compared to the LPBF-optimized In939. Although the observed elongation of around 13-15% is lower compared to LPBF-optimized In939 (which was around 25%), such tensile elongation is still quite respectable. Moreover, FIGS. 11A-11B provide σ_{YS} and σ_{UTS} comparison plots of several LPBF processed In718 composites and LPBF'ed+heat treated In939. As shown, yield strength (σ_{YS}), ultimate tensile strength (σ_{UTS}), and tensile strain of non-heat treated In939+TiB₂ are higher than those of LPBF'ed and heat-treated In718+SiC, In718+TiC and In939, which used to be the highest strength-ductility pair among superalloys.

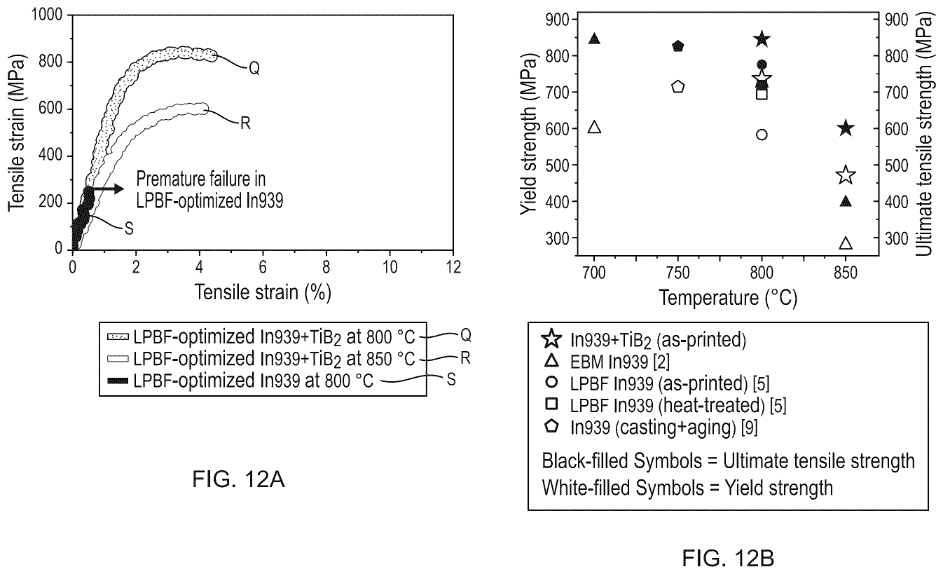

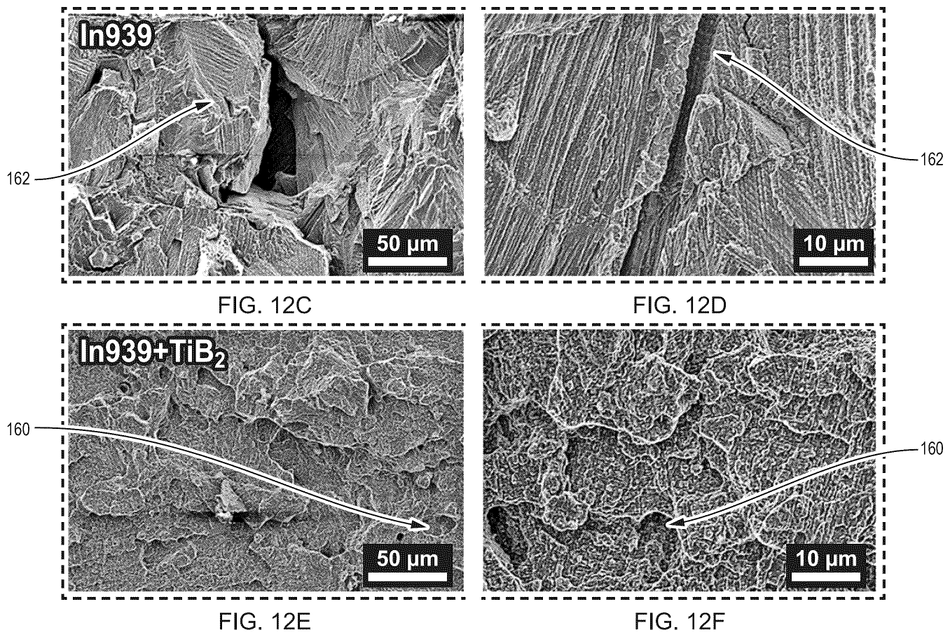

FIG. 12A illustrates stress-strain curves for In939 (curve Q) and In939+TiB₂ at 800° C. (curve R) and 850° C. (curve S). As shown, pure In939 (S) is observed to experience premature failure in the elastic region. This phenomenon is likely due to the printing defects, e.g. pre-existing cracks with lengths up to 0.5 mm and widths up to 0.01 mm within the In939 samples. Given the ˜0.4 mm thickness of the samples for high-temperature tensile testing, it is inferred that these pre-existing cracks could easily lead to premature failure. This is further supported by FIG. 12B, which illustrates high-temperature yield and ultimate tensile strengths of In939+TiB₂ compared to other In939 alloy as reported in the literature. As shown, high-temperature yield and ultimate tensile strengths of In939+TiB₂ exhibit superior performance to that of other alloys. The high-temperature properties of LPBF-optimized In939+TiB₂ composite, which showed no premature failure, are summarized in Table 3 below and FIG. 12B, alongside the corresponding properties of In939 from the literature. FIG. 12B demonstrates that LPBF-optimized In939+TiB₂ can possess superior yield strength (YS) and ultimate tensile strength (UTS) at elevated temperatures. Notably, at 800° C., the YS, and UTS of LPBF-optimized In939+TiB₂ can surpass those of both LPBF'ed and LPBF'ed+heat-treated In939. Moreover, when compared to electron beam melted (EBM) In939 tested at 700° C., LPBF-optimized In939+TiB₂ can exhibit higher YS and comparable UTS at 800° C., despite the 100° C. increase in the testing temperature. Further still, the YS and UTS of LPBF-optimized In939+TiB₂ at 800° C. can be higher than those of cast+aged In939 at 750° C.

FIGS. 12C-12F illustrate the fracture surfaces of In939 and In939+TiB₂ after testing at 800° C. at each of 50 μm and 10 μm magnification. In the case of In939+TiB₂, as shown in FIGS. 12E-12F, the observations unveil cleavage fracture characteristics as well as indications of ductile fracture, as evidenced by void and dimple formation 160. In contrast, as shown in FIGS. 12C-12D, In939 can exhibit surface features indicative of purely brittle fracture, marked by rapid crack propagation from pre-existing cracks 162.

TABLE 3
Comparison of 800° C. and 850° C. tensile properties of LPBF-optimized
In939 + TiB₂ and other In939 materials from the literature.

| | | Temp. | YS | UTS | El |
|---|---|---|---|---|---|
| Material | Condition | (° C.) | (MPa) | (MPa) | (%) |
| In939 [2] | EBM | 700 | 601 | 843 | 11 |
| | | 850 | 282 | 397 | 7.5 |
| In939 [5] | LPBF | 800 | 582 | 775 | 8 |
| | LPBF + heat- | 800 | 694 | 720 | 9 |
| | treated | | | | |
| In939 [9] | Cast + aged | 750 | 713 | 825 | 3 |
| In939 + TiB₂ | LPBF | 800 | 734 ± 9 | 845 ± 2 | 2.9 ± 1.0 |
| (This study) | (as-printed) | 850 | 471 | 603 | 4.1 |

Yet another exemplary composition provided for herein can use CMSX-4, a second generation, single-crystal nickel-based superalloy as the foundation or base metal with which additives discussed above are mixed, blended, or otherwise combined. Notably, the techniques of the present embodiments that include CMSX-4 as the base can achieve further improvement in strength and high temperature durability, with the present compositions and methodology improving printability and decreasing/eliminating solidification cracking, particularly with regards to low-weldability materials. Further, as above, various features, embodiments, and compositions discussed above with respect to In718 and In939 can be combined and/or may apply to compositions that include CMSX-4.

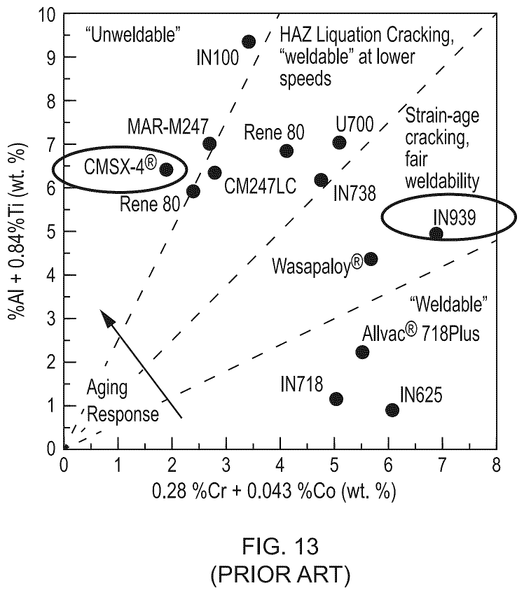

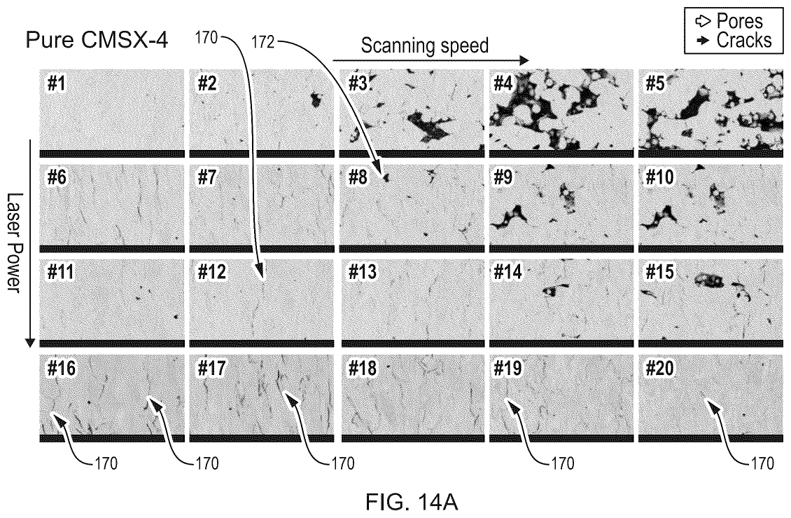

CMSX-4 can be used in aerospace and power generation industries due to its exceptional high-temperature mechanical properties, which surpass those of many earlier nickel superalloys. This is largely due to its optimized chemical composition and advanced heat treatment processes, which enhance its strength, creep resistance, and oxidation resistance at elevated temperatures. Despite these advantages, CMSX-4 has posed some challenges in terms of weldability and printability. Its complex microstructure, designed for maximum high-temperature performance, makes it susceptible to cracking and defects during additive manufacturing processes. FIG. 13 illustrates a weldability chart of Nickel based superalloy family applications of alloy design to cracking resistance of additively manufactured Ni-based alloys. As shown, CMSX-4 exhibits far poorer weldability than either of In939 and/or In718, which are categorized as having fair weldability and being weldable, respectively. These challenges necessitate specialized techniques and careful process control to achieve high-quality printed components.

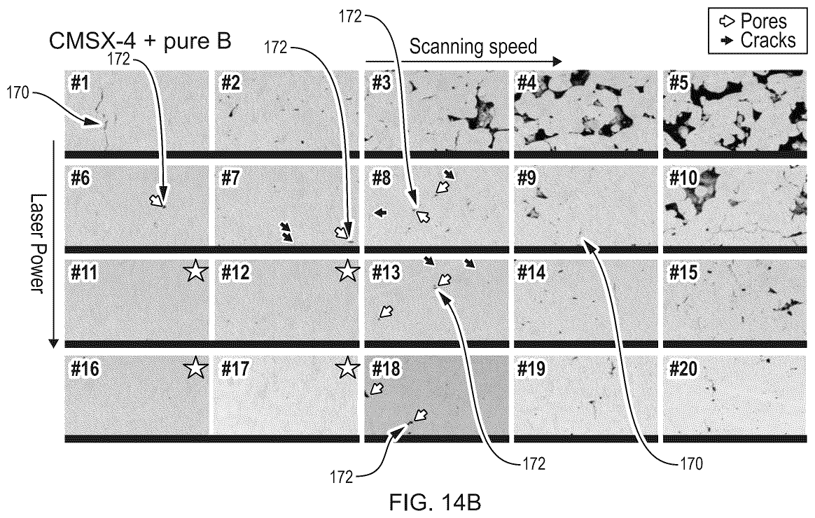

Just as discussed above with respect to the other bases, CMSX-4 can be combined with other additives, such as B and TiB₂, among others. For example, preliminary printing trials performed on pure CMSX-4 and CMSX-4+0.5 wt % pure B under different printing parameters show that addition of pure B can help mitigate crack formation in poor-weldable CMSX-4 alloy under certain printing conditions. FIG. 14A is a cross-sectional SEM image showing defect distributions in CMSX-4 as a function of scanning speed and laser power and FIG. 14B is a cross-sectional SEM image showing defect distributions in CMSX-4+0.5 wt % pure B as a function of scanning speed and laser power. As shown in samples #4, #5, #9, #10, #14, and #15 of pure CMSX-4, particularly at higher scanning speeds and low laser powers, large amounts of defects can occur. Moreover, at lower scanning speeds and high laser powers, such as samples #12, #16, #17, and others, formation of cracks 170 and pores 172 can occur.

When the CMSX-4 is mixed with pure B, as in CMSX-4+0.5 wt % pure B of FIG. 14B, the number of cracks 170 and pores 172 can be significantly reduced, particularly at higher scanning speeds and low laser powers (samples #12, #16, #17, and others delineated with a “star symbol.” As a result, the composites of CMSX-4+0.5 wt % pure B can be used to significantly mitigate crack formation in poor-weldable CMSX-4 alloys, making such products particularly appealing in aerospace and other similar high pressure applications.

One skilled in the art will appreciate further features and advantages of the disclosures based on the provided for descriptions and embodiments. Accordingly, the inventions are not to be limited by what has been particularly shown and described. To the extent the present disclosure includes illustrations and descriptions that include prototypes, bench models, or schematic illustrations of set-ups, a person skilled in the art will recognize how to rely upon the present disclosure to integrate the techniques, systems, devices, and methods provided for into a product and/or production method. All publications and references cited herein are expressly incorporated herein by reference in their entirety.

Some non-limiting claims that are supported by the contents of the present disclosure are provided below.

What is claimed is:

1. A composition, comprising:
a Nickel-superalloy powder; and
additive particles of an additive powder, the Nickel-superalloy powder combining with the additive particles to form a plurality of composition particles of a composition powder,
wherein a volume percent of the Nickel-superalloy powder is approximately in a range of about 90 vol % to about 99.5 vol %,
wherein a volume percent of the additive particles is approximately in a range of about 0.5 vol % to about 10 vol %,
wherein an average diameter of each particle of the plurality of composition particles is about 40 μm or less, and
wherein a sphericity of a majority of particles of the plurality of composition particles is at least about 90% as compared to a perfect sphere.

2. The composition of claim 1, wherein a diameter of each particle of the plurality of composition particles is less than about 100 μm.

3. The composition of claim 1, wherein the Nickel-superalloy powder comprises at least one of Inconel 718, CMSX-4 or Inconel 939.

4. The composition of claim 1, wherein the additive particles further comprise ceramic additive particles that include at least one of silicon carbide, titanium diboride, zirconium diboride, hafnium carbide, tantalum carbide, hafnium diboride, tantalum diboride, tungsten disilicide, tantalum disilicide, or hafnium disilicide.

5. The composition of claim 4,
wherein the Nickel-superalloy powder comprises CMSX-4, and
wherein the ceramic additive particle comprises titanium diboride.

6. The composition of claim 1, wherein the additive particle comprises pure Boron.

7. The composition of claim 1,
wherein the Nickel-superalloy powder comprises CMSX-4, and
wherein the additive particle comprises pure Boron.

8. The composition of claim 1, wherein the composition is formulated by:
at least one of mixing or blending the Nickel-superalloy powder with the ceramic additive particles to formulate the plurality of composition particles;
sieving the plurality of composition particles such that each particle of the plurality of composition particles has an average diameter that is about 40 μm or less;
spreading the plurality of composition particles such that they have a substantially uniform thickness across a surface; and
applying heat to the particles to formulate the composition.

9. A printed part comprising the composition of claim 1.

10. The printed part of claim 9, wherein the printed part is formed by laser powder bed fusion.

11. The printed part of claim 9, wherein the printed part is configured for use in at least one of a high-irradiation environment (e.g., fusion reactor, advanced fission reactor) or a high-temperature environment (e.g., exceeding approximately 600° C., turbines).

12. A method of formulating a metal matrix composition, comprising:
at least one of mixing or blending a Nickel-superalloy powder with additive particles to formulate a plurality of composition particles of a metal matrix composition;
sieving the plurality of composition particles such that each particle of the plurality of composition particles has an average diameter that is about 40 μm or less;
spreading the plurality of composition particles such that they have a substantially uniform thickness across a surface; and
applying heat to the composition particles to formulate the metal matrix composition.

13. The method of claim 12, wherein at least one of mixing or blending a Nickel-superalloy powder with additive particles further comprises ball milling the Nickel-superalloy powder with the additive particles.

14. The method of claim 12, wherein the Nickel-superalloy powder comprises at least one of Inconel 718, CMSX-4, or Inconel 939.

15. The method of claim 12, wherein the additive particle comprises pure Boron.

16. The method of claim 12, wherein the additive particles further comprise ceramic additive particles that include at least one of silicon carbide, titanium diboride, zirconium diboride, hafnium carbide, tantalum carbide, hafnium diboride, tantalum diboride, tungsten disilicide, tantalum disilicide, or hafnium disilicide.

17. The method of claim 16,
wherein the Nickel-superalloy powder comprises CMSX-4, and
wherein the ceramic additive particle comprises silicon carbide.

18. The method of claim 16,
wherein the Nickel-superalloy powder comprises CMSX-4, and
wherein the ceramic additive particle comprises zirconium diboride.

19. An additive manufacturing printer, comprising:
a formulation chamber in which a material for printing is formulated;
a platform configured to receive the formulated material from the formulation chamber; and
a heating component configured to harden the formulated material in conjunction with printing a printed part.

20. The additive manufacturing printer of claim 19, wherein the formulation chamber is configured to have the composition of claim 1 formulated therein.
